(19) United States
(12) Patent Application Publication
(10) Pub. No.: US 2013/0103241 A1
(43) Pub. Date: Apr. 25, 2013

(54) VEHICLE CONTROL UNIT AND CONTROL METHOD

(71) Applicant: Yoshio Koide, Saitama (JP)

(72) Inventor: Yoshio Koide, Saitama (JP)

(73) Assignee: Honda Motor Co., Ltd, Tokyo (JP)

(21) Appl. No.: 13/697,717

(22) PCT Filed: May 19, 2011
(86) PCT No.: PCT/JP2011/061579

§ 371 Date: Nov. 13, 2012

(30) Foreign Application Priority Data
Jun. 28, 2010 (JP) 2010-146291

(51) Int. Cl. B60W 20/00

(52) U.S. Cl. CPC B60W 20/30; Y10S 903/903
USPC 701/22; 180/65.275; 903/903

(57) ABSTRACT

A control unit for use in a vehicle including an internal combustion engine, an electric motor, a battery that supplies electric power to the electric motor, and a transmission that transmits a driving force from at least one of the internal combustion engine and the electric motor to drive shafts prohibits a gear change in the transmission at least while the vehicle is cornering when a cornering of the vehicle is detected by a cornering detection device and permits an assist increase by the electric motor with the gear change in the transmission kept prohibited when a storage state of the battery satisfies a first storage condition. Consequently, a smooth re-acceleration can be realized during a cornering of the vehicle which involves acceleration and deceleration thereof.

### TECHNICAL FIELD

The present invention relates to a vehicle control unit and control method for controlling the driving of a vehicle around a bend or corner in a road which involves acceleration and deceleration of the vehicle.

### BACKGROUND ART

In a winding road driving which involves cornering, as well as acceleration and deceleration of a vehicle, it becomes important that a driving force is ensured in response to an accelerator pedal operation by the driver. However, when a gear change occurs in an automatic transmission while the vehicle is cornering, the driving force changes, and the behaviors of the vehicle are disturbed. To cope with this, a gear change controller is considered in which when a corner is detected based on a centrifugal acceleration applied to the vehicle or a difference in wheel speed, a gear change in an automatic transmission is prohibited, while the vehicle is cornering, the gear engaged is kept engaged, and a gear change is permitted after the vehicle has left the corner.

When the driver depresses the accelerator pedal immediately after the vehicle has left the corner, the gear change controller executes a kickdown control in which a lower gear than the gear automatically engaged by the automatic transmission is selected in order to satisfy a required driving force that corresponds to the accelerator pedal operation. Then, when the vehicle is driven to cruise, the gear change controller executes an upshift in which an upper gear than the gear engaged as a result of the kickdown control is selected. In this way, the gear change is performed frequently until the vehicle is driven to cruise after it has left the corner.

Incidentally, when a hybrid vehicle that can be driven by a driving force not only from an engine but also from a motor is decelerated before the hybrid vehicle enters a corner and is then accelerated again after it has left the corner, the hybrid vehicle is driven in an electrical driving (EV) mode while the hybrid vehicle is decelerated, and when it is accelerated again, the driving mode of the hybrid vehicle is switched to a hybrid (HEV) mode so as to ensure a desired driving force. However, in order to switch from the EV mode to the HEV mode, the engine needs to be started. Additionally, a predetermined time period is necessary to start the engine. Further, when the motor that is the drive source is used to start the engine, the torque necessary to drive the vehicle cannot be ensured sufficiently.

Therefore, in a hybrid vehicle described in Patent Literature 1, when the hybrid vehicle is in a sport driving state, a mode switching device that switches driving modes changes a boundary between an electrical driving mode area and a hybrid driving mode area from an original position associated with a normal driving state towards the electrical driving mode area so as to widen the hybrid driving mode area. Since the hybrid driving mode area is widened in this way when the driving state of the hybrid vehicle is changed from the normal driving state to the sport driving state, even when the hybrid vehicle is decelerated and accelerated frequently on a winding road with the hybrid driving mode maintained, the engine is not started at all. Consequently, no time lag is generated until the vehicle can be accelerated in the hybrid driving mode. In addition, no torque needs to be ensured for starting the engine, and therefore, the torque needed to drive the vehicle can be increased. Thus, even when the vehicle is abruptly switched from the decelerating driving to the accelerating driving, it is possible to realize the acceleration performance that coincides with the driver's intention to accelerate the vehicle.

### RELATED ART LITERATURE

### Patent Literature

### Patent Literature 1: JP-2008-168700-A

### Patent Literature 2: JP-2005-299879-A

### Patent Literature 3: JP-H08-135783-A

### SUMMARY OF THE INVENTION

### Problem that the Invention is to Solve

As described above, the gear change is performed frequently until the vehicle that is driven on the winding road attains the cruising driving after it has left the corner. The gear change involves a shock and a change in driving force. Because of this, when the vehicle is accelerated again after it has left the corner, it is not possible to make the driver feel a sensation of smooth acceleration.

An object of the invention is to provide a vehicle control unit and control method that can realize a smooth re-acceleration in cornering which involves acceleration and deceleration.

### Means for Solving the Problem

Claim 1 provides a vehicle control unit (e.g., a control unit 2 in embodiment) for use in a vehicle including:

an internal combustion engine (e.g., an engine 6 in embodiment);

an electric motor (e.g., a motor 7 in embodiment);

a battery (e.g., a battery 3 in embodiment) that supplies electric power to the electric motor; and

a transmission (e.g., a transmission 20 in embodiment) that transmits a driving force from at least one of the internal combustion engine and the electric motor to drive shafts,

wherein, when a cornering of the vehicle is detected by a cornering detection device (e.g., wheel speed sensors SL, SR or a centrifugal acceleration sensor SG in embodiment), a gear change in the transmission is prohibited at least when the vehicle is cornering, and when a storage state of the battery satisfies a first storage condition, an assist increase by the electric motor is permitted with the gear change in the transmission kept prohibited.

Claim 2 provides the control unit,

wherein, when an accelerator pedal operation of an accelerator pedal of the vehicle satisfies a predetermined condition within a predetermined time period from a time point when an end of the cornering of the vehicle is detected by the cornering detection device, an assist increase in the electric motor is permitted, whereas when the accelerator pedal operation of the accelerator pedal of the vehicle does not satisfy the predetermined condition, the prohibition of the gear change in the transmission is cancelled.

Claim 3 provides the control unit,

wherein, when the storage state of the battery does not satisfy the first storage condition, the prohibition of the gear change in the transmission is cancelled at the end of cornering of the vehicle.

Claim 4 provides the control unit,

wherein, when the storage state of the battery satisfies a second storage condition while the vehicle is cornering which is driven only by a driving force from the electric motor, a start of the internal combustion engine is prohibited.

Claim 5 provides the control unit,

wherein, when the storage state of the battery does not satisfy the second storage condition while the vehicle is cornering which is driven only by the driving force from the electric motor, it is controlled so that a start of the internal combustion engine by the electric motor is implemented.

Claim 6 provides the control unit,

wherein the transmission includes:
a first input shaft (e.g., a first main shaft 11 in embodiment) that is connected to the electric motor and which is selectively connected to the internal combustion engine via a first engaging and disengaging mechanism (e.g., a first clutch 41 in embodiment);
a second input shaft (e.g., a second intermediate shaft 16 in embodiment) that is selectively connected to the internal combustion engine via a second engaging and disengaging mechanism (e.g., a second clutch 42 in embodiment);
an output shaft (e.g., a counter shaft 14 in embodiment) that outputs power to driven portions (e.g., driven wheels WL, WR in embodiment);
a first gear set made up of a plurality of odd-numbered gears (e.g., a planetary gear mechanism 30, a third speed drive gear 23a, a fifth speed drive gear 25a in embodiment) that are disposed on the first input shaft and which are selectively connected to the first input shaft via a first synchronizing unit (e.g., a lock mechanism 61, a first gear shifter 51 in embodiment);
a second gear set made up of a plurality of even-numbered gears (e.g., a second speed drive gear 22a, a fourth speed drive gear 24a in embodiment) that are disposed on the second input shaft and which are selectively connected to the second input shaft via a second synchronizing unit (e.g., a second gear shifter 52 in embodiment); and
a third gear set made up of a plurality of gears (e.g., a first common driven gear 23b, a second common driven gear 24b in embodiment) that are disposed on the output shaft and with which the odd-numbered gears of the first gear set and the even-numbered gears of the second gear set are brought into meshing engagement.

Claim 7 provides the control unit,

wherein, when the vehicle is cornering such that the first engaging and disengaging mechanism is released while the second engaging and disengaging mechanism is applied, the transmission is controlled so that the first input shaft is connected to one of the odd-numbered gears of the first gear set via the first synchronizing unit.

Claim 8 provides the control unit,

wherein an odd-numbered gear of the first gear set that is connected to the first input shaft is lower than an even-numbered gear of the second gear set that is connected to the second input shaft.

Claim 9 provides the control unit,

wherein, when a sport mode is selected in which a driving performance of the vehicle is emphasized, an odd-numbered gear that is lower than an even-numbered gear of the second gear set that is connected to the second input shaft is connected to the first input shaft.

Claim 10 provides the control unit,

wherein, when a fuel economy prioritizing mode is selected in which fuel economy is prioritized, an odd-numbered gear that is upper than an even-numbered gear of the second gear set that is connected to the second input shaft is connected to the first input shaft.

Claim 11 provides the control unit,

wherein the predetermined time period that is set when a sport mode is selected in which a driving performance of the vehicle is emphasized or when a gear change in the transmission is implemented manually is set longer than a time period set in a normal state.

Claim 12 provides the control unit,

wherein the vehicle includes a car navigation system, and

wherein a gear to be engaged in the transmission is set according to a bend in a road that the vehicle is about to enter based on information on the bend that is obtained from the car navigation system.

Claim 13 provides a vehicle control method for use in a vehicle including:

an internal combustion engine (e.g., an engine 6 in embodiment);

an electric motor (e.g., a motor 7 in embodiment);

a battery (e.g., a battery 3 in embodiment) that supplies electric power to the electric motor;

a transmission (e.g., a transmission 20 in embodiment) that transmits a driving force from at least one of the internal combustion engine and the electric motor to drive shafts; and

a control unit (e.g., a control unit 2 in embodiment) that controls the electric motor and the transmission,

wherein, when a cornering of the vehicle is detected, the control unit prohibits a gear change in the transmission at least when the vehicle is cornering, and when a storage state of the battery satisfies a first storage condition, the control unit permits an assist increase in the electric motor with the gear change in the transmission kept prohibited.

### Advantage of the Invention

According to the vehicle control unit of claims 1 to 12 and the vehicle control method of claim 13, it is possible to realize a smooth re-acceleration in cornering which involves acceleration and deceleration.

According to the vehicle control unit of claim 2, the frequent gear change can be prevented by accelerating the vehicle based on the assist increase in the electric motor instead of changing gears in the transmission within the predetermined time period from the end of cornering of the vehicle. In addition, an improvement in fuel economy can be realized by making use of the electric motor.

According to the vehicle control unit of claim 3, although a gear change is prohibited while the vehicle is cornering, the prohibition of gear change in the transmission is cancelled after the end of cornering of the vehicle, and therefore, the re-acceleration performance can be maintained.

According to the vehicle control unit of claim 4, power needed to start the internal combustion engine is unnecessary.

According to the vehicle control unit of claim 5, the internal combustion engine can be started before the re-acceleration after the end of cornering of the vehicle.

According to the vehicle control unit of claim 6, the same advantages can also be attained in a dual-clutch transmission.

According to the vehicle control unit of claims 7 to 10, a pre-shift can be implemented in the transmission.

According to the vehicle control unit of claim 11, the driving of the vehicle can be attained in which the smooth acceleration performance by the assist increase in the electric motor is emphasized.

According to the vehicle control unit of claim 12, the gear change can be set to occur at an appropriate gear in the transmission before the vehicle enters a bend in a road.

### BRIEF DESCRIPTION OF THE DRAWINGS

FIG. 1 shows an internal configuration of an HEV of an embodiment of the invention.

FIG. 2 shows sectional views of a motor 7 and a transmission 20.

FIG. 3 conceptually shows internal configurations of the motor 7 and the transmission 20.

FIG. 4 conceptually shows a cornering of the vehicle.

FIG. 5 is a timing chart when the vehicle is cornering.

FIG. 6 is a flowchart showing a control implemented by a control unit 2 when the vehicle is cornering.

FIG. 7 shows an internal configuration of an HEV that includes a transmission according to a different embodiment.

### MODE FOR CARRYING OUT THE INVENTION

Embodiments of the invention will be described by reference to the drawings.

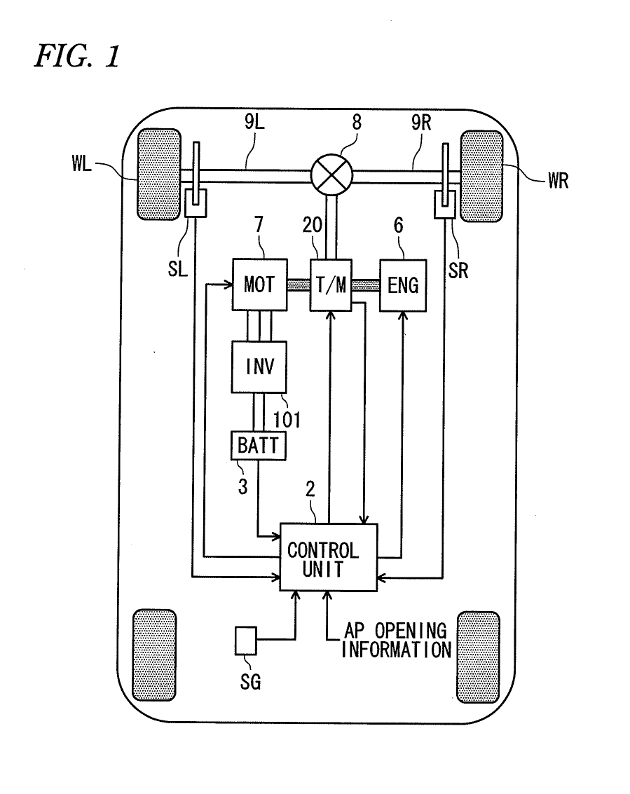

An HEV (Hybrid Electrical Vehicle) is driven by driving force of an internal combustion engine (engine) and/or an electric motor (motor). FIG. 1 shows an internal configuration of an HEV according to an embodiment of the invention. The HEV (vehicle) shown in FIG. 1 includes an engine (ENG) 6 as a drive source, a motor (MOT) 7 as a drive source, a battery (BATT) 3, an inverter (INV) 101, a transmission (T/M) 20, wheel speed sensors SL, SR, a centrifugal acceleration sensor SG and a control unit 2.

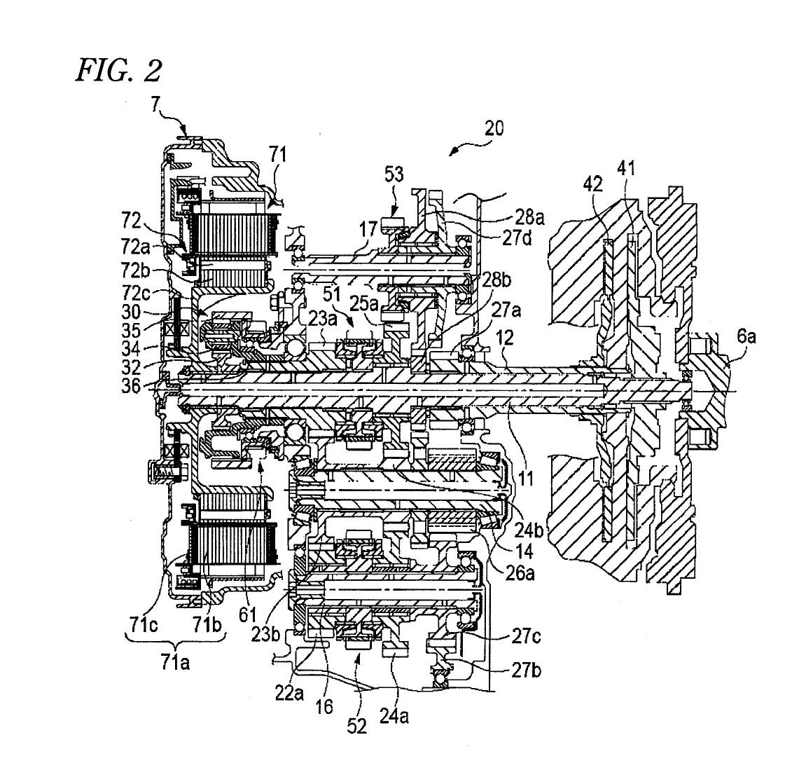

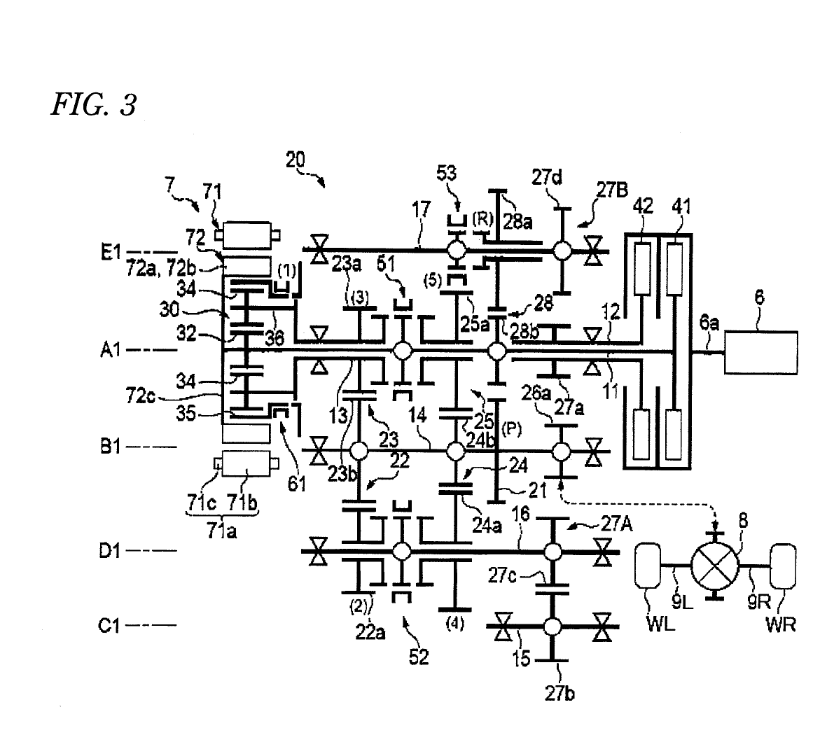

Hereinafter, relationships between the constituent elements and an internal configuration of the transmission 20 will be described by reference to FIGS. 2 and 3. FIG. 2 shows sectional views of the motor 7 and the transmission 20. FIG. 3 conceptually shows internal configurations of the motor 7 and the transmission 20.

The engine 6 is, for example, a gasoline engine or a diesel engine, and a crankshaft 6a of this engine 6 carries a first clutch 41 (a first engaging and disengaging mechanism) and a second clutch (a second engaging and disengaging mechanism) 42 of the transmission 20.

The motor 7 is a three-phase brushless DC motor and has a stator 71 that is made up of 3n armatures 71 a and a rotor 72 that is disposed opposite to the stator 71. Each armature 71a includes an iron core 71b and a coil 71c that is wound round this iron core 71b. The armatures 71a are fixed to a casing, not shown, and are aligned at substantially equal intervals in a circumferential direction about a rotational shaft. 3n coils 71c make up n sets of coils of three phases including a U phase, a V phase and a W phase.

The rotor 72 has an iron core 72a and n permanent magnets 72b which are aligned at substantially equal intervals in a circumferential direction about the rotational shaft. Polarities of any two adjacent permanent magnets 72b are different from each other. A fixing portion 72c that fixes the iron core 72a in place has a hollow cylindrical shape, is disposed on an outer circumferential side of a ring gear 35 of a planetary gear mechanism 30, which will be described later, and is connected to a sun gear 32 of the planetary gear mechanism 30. Thus, the rotor 72 is made to rotate together with the sun gear 32 of the planetary gear mechanism 30.

The planetary gear mechanism 30 has the sun gear 32, the ring gear 35 which is disposed so as not only to be concentric with the sun gear 32 but also to surround the periphery of the sun gear 32, planetary gears 34 which are in mesh with the sun gear 32 and the ring gear 35 and a carrier 36 which supports the planetary gears 34 so as to allow them not only to rotate on their own axes but also to walk around the sun gear 32. Thus, the sun gear 32, the ring gear 35 and the carrier 36 are made to rotate differentially relative to each other.

A lock mechanism 61 (a synchronizer mechanism), which has a synchronizing mechanism (a synchronizer mechanism) and which is made to stop (lock) the rotation of the ring gear 35, is provided on the ring gear 35. A brake mechanism may be used in place of the lock mechanism 61.

As shown in FIG. 1, the motor 7 is connected to the battery 3 via the inverter 101. The battery 3 has a plurality of battery cells that are connected in series and supplies a high voltage of 100 to 200 V, for example. The battery cell is, for example, a lithium ion battery or a nickel-metal hydride battery. The inverter 101 converts a direct current voltage from the battery 3 into an alternating current voltage based on a switching action of a switching element and then supplies the resulting alternating current voltage to the three-phase current motor 7. Additionally, the inverter 101 converts an alternating current voltage that is inputted thereinto when the motor 7 performs a regenerative operation into a direct current voltage with which the battery 3 is charged. Consequently, the motor 7 is driven by electric power supplied from the battery 3 and generates electric energy in a regenerative fashion through rotation of driven wheels WL, WR during deceleration of the vehicle or by the power of the engine 6 so as to charge the battery 3 (recover energy). The motor 7 is also used to start the engine 6.

The transmission 20 is a so-called dual-clutch transmission for transmitting power from the engine 6 and/or the motor 7 to the driven wheels WL, WR. The transmission 20 includes the first clutch 41, the second clutch 42 and the planetary gear mechanism 30, which have been described before, as well as a plurality of change-speed gear sets, which will be described later.

More specifically, the transmission 20 includes a first main shaft 11 (a first input shaft) that is disposed coaxially with the crankshaft 6a of the engine 6 (a rotational axis A1), a second main shaft 12, a connecting shaft 13, a counter shaft 14 (an output shaft) that is rotatable about a rotational axis B1 disposed parallel to the rotational axis A1, a first intermediate shaft 15 that is rotatable about a rotational axis C1 disposed parallel to the rotational axis A1, a second intermediate shaft 16 (a second input shaft) that is rotatable about a rotational axis D1 disposed parallel to the rotational axis A1 and a reverse shaft 17 that is rotatable about a rotational axis E1 disposed parallel to the rotational axis A1.

The first clutch 41 is provided on the first main shaft 11 at an end lying to face the engine 6, and the sun gear 32 of the planetary gear mechanism 30 and the rotor 72 of the motor 7 are mounted on an end of the first main shaft 11 which lies opposite to the end facing the engine 6. Consequently, the first main shaft 11 is selectively connected to the crankshaft 6a of the engine 6 by the first clutch 41 and is connected directly to the motor 7, thus power of the engine 6 and/or the motor 7 being transmitted to the sun gear 32.

The second main shaft 12 is formed shorter than the first main shaft 11 and hollow and is disposed so as to rotate relative to the first main shaft 11 while surrounding the periphery of an end portion of the first main shaft 11 which lies to face the engine 6. The second clutch 42 is provided at an end of the second main shaft 12 which lies to face the engine 6, and an idle drive gear 27a is mounted integrally on an end portion of the second main shaft 12 which lies opposite to the end facing the engine 6. Consequently, the second main shaft 12 is selectively connected to the crankshaft 6a of the engine 6 by the second clutch 42, so that power of the engine 6 is transmitted to the idle drive gear 27a.

The connecting shaft 13 is formed shorter than the first main shaft 11 and hollow and is disposed so as to rotate relative to the first main shaft 11 while surrounding the periphery of an end portion of the first main shaft 11 which lies opposite to the end facing the engine 6. A third speed drive gear 23a is mounted integrally on an end portion of the connecting shaft 13 which lies to face the engine 6, and the carrier 36 of the planetary gear mechanism 30 is mounted on an end portion of the connecting shaft 13 which lies opposite to the end portion lying to face the engine 6. Consequently, the carrier 36 and the third speed drive gear 23a which are mounted on the connecting shaft 13 are made to rotate together when the planetary gears 34 walk around the sun gear 32.

A fifth speed drive gear 25a is provided on the first main shaft 11 so as to rotate relative to the first main shaft 11. A reverse driven gear 28b is also mounted on the first main shaft 11 so as to rotate together therewith. A first gear shifter 51 (a first synchronizing unit) is provide between the third speed drive gear 23a and the fifths speed drive gear 25a, and this first gear shifter 51 connects or disconnects the first main shaft 11 with or from the third speed drive gear 23a or the fifth speed drive gear 25a. When the first gear shifter 51 is engaged in a third speed engaging position, the first main shaft 11 is connected to the third speed drive gear 23a so as to rotate together therewith. When the first gear shifter 51 is engaged in a fifth speed engaging position, the first main shaft 11 rotates together with the fifth speed drive gear 25a. When the first gear shifter 51 is in a neutral position, the first main shaft 11 rotates relative to the third speed drive gear 23a and the fifth speed drive gear 25a. When the first main shaft 11 and the third speed drive gear 23a rotate together, the sun gear 32 that is mounted on the first main shaft 11 rotates together with the carrier 36 that is connected to the third speed drive gear 23a via the connecting shaft 13, and the ring gear 35 also rotate together therewith, whereupon the planetary gear mechanism 30 is brought into a solid unit. When the lock mechanism 61 is applied with the first gear shifter 51 staying in the neutral position, the ring gear 35 is locked, and the rotation of the sun gear 32 is transmitted to the carrier 36 while being decelerated.

A first idle driven gear 27b is mounted integrally on the first intermediate shaft 15, and this first idle driven gear 27b meshes with the idle drive gear 27a that is mounted on the second main shaft 12.

A second idle driven gear 27c is mounted integrally on the second intermediate shaft 16, and the second idle driven gear 27c meshes with the first idle driven gear 27b that is mounted on the first intermediate shaft 15. The second idle driven gear 27c makes up a first idle gear train 27A together with the idle drive gear 27a and the first idle driven gear 27b which have been described before. A second speed drive gear 22a and a fourth speed drive gear 24a are provided on the second intermediate shaft 16 in positions which correspond, respectively, to the third speed drive gear 23a and the fifth speed drive gear 25a which are provided around the first main shaft 11, the second speed drive gear 22a and the fourth speed drive gear 24a being individually made to rotate relative to the second intermediate shaft 16. A second gear shifter 52 (a second synchronizing unit) is provided on the second intermediate shaft 16 in a position lying between the second speed drive gear 22a and the fourth speed drive gear 24a, and this second gear shifter 52 connects or disconnects the second intermediate shaft 16 with or from the second speed drive gear 22a or the fourth speed drive gear 24a. When the second gear shifter 52 is engaged in a second speed engaging position, the second intermediate shaft 16 rotates together with the second speed drive gear 22a. When the second gear shifter 52 is engaged in a fourth speed engaging position, the second intermediate shaft 16 rotates together with the fourth speed drive gear 24a. When the second gear shifter 52 is in a neutral position, the second intermediate shaft 16 rotates relative to the second speed drive gear 22a and the fourth speed drive gear 24a.

A first common driven gear 23b, a second common driven gear 24b, a parking gear 21 and a final gear 26a are mounted integrally on the counter shaft 14 sequentially in that order as seen from an opposite end of the counter shaft 14 to an end which lies to face the engine 6.

Here, the first common driven gear 23b meshes with the third speed drive gear 23a that is mounted on the connecting shaft 13 and then makes up a third speed gear pair 23 together with the third speed drive gear 23a and meshes with the second speed drive gear 22a that is provided on the second intermediate shaft 16 and then makes up a second speed gear pair 22 together with the second speed drive gear 22a.

The second common driven gear 24b meshes with the fifth speed drive gear 25a that is provided on the first main shaft 11 and then makes up a fifth speed gear pair 25 together with the fifth speed drive gear 25a and meshes with the fourth speed drive gear 24a that is provided on the second intermediate shaft 16 and then makes up a fourth speed gear pair 24 together with the fourth speed drive gear 24a.

The final gear 26a meshes with the differential gear mechanism 8, and the differential gear mechanism 8 is connected to the driven wheels WL, WR via drive shafts 9L, 9R. Consequently, power that is transmitted to the counter shaft 14 is outputted from the final gear 26a to the differential gear mechanism 8, the drive shafts 9L, 9R and the driven wheels WL, WR.

A third idle driven gear 27d is mounted integrally on the reverse shaft 17, and this third idle driven gear 27d meshes with the first idle driven gear 27b that is mounted on the first intermediate shaft 15. The third idle driven gear 27d makes up a second idle gear train 27B together with the idle drive gear 27a and the first idle driven gear 27b which have been described before. A reverse drive gear 28a is provided on the reverse shaft 17 so as to rotate relative to the reverse shaft 17, and this reverse drive gear 28a meshes with a reverse driven gear 28b that is mounted on the first main shaft 11. The reverse drive gear 28a makes up a reverse gear train 28 together with the reverse driven gear 28b. A reverse shifter 53 is provided on the reverse shaft 17 in a position lying on a side of the reverse drive gear 28a which lies opposite to a side facing the engine 6. This reverse shifter 53 connects or disconnects the reverse shaft 17 with or from the reverse drive gear 28a. When the reverse shifter 53 is engaged in a reverse engaging position, the reverse shaft 17 rotates together with the reverse drive gear 28a, and when the reverse shifter 53 is in a neutral position, the reverse shaft 17 rotates relative to the reverse drive gear 28a.

The first gear shifter 51, the second gear shifter 52 and the reverse shifter 53 employ clutch mechanisms having a synchronizing mechanism (a synchronizer mechanism) for matching the rotational speeds of a shaft and a gear which are connected together thereby.

In the transmission 20, an odd-numbered gear set (a first gear set) made up of the third speed drive gear 23a and the fifth speed drive gear 25a is provided on the first main shaft 11, which is one change-speed shaft of two change-speed shafts, and an even-numbered gear set (a second gear set) made up of the second speed drive gear 22a and the fourth speed drive gear 24a is provided on the second intermediate shaft 16, which is the other change-speed shaft of the two change-speed shafts. The even-numbered gear set may have further a sixth speed drive gear and the odd-numbered gear set of the transmission 20 may have further a seventh speed drive gear.

Thus, the transmission 20 of this embodiment has the following first to fifth transmission lines.

(1) In a first transmission line, the crankshaft 6a of the engine 6 is connected to the driven wheels WL, WR via the first main shaft 11, the planetary gear mechanism 30, the connecting shaft 13, the third speed gear pair 23 (the third speed drive gear 23a, the first common driven gear 23b), the counter shaft 14, the final gear 26a, the differential gear mechanism 8 and the drive shafts 9L, 9R. Here, a reduction ratio of the planetary gear mechanism 30 is set so that engine torque that is transmitted to the driven wheels WL, WR by way of the first transmission line corresponds to a first speed. Namely, the reduction ratio of the planetary gear mechanism 30 is set so that a reduction ratio resulting from multiplication of the reduction ratio of the planetary gear mechanism 30 by the gear ratio of the third speed gear pair 23 corresponds to the first speed.

(2) In a second transmission line, the crankshaft 6a of the engine 6 is connected to the driven wheels WL, WR via the second main shaft 12, the first idle gear train 27A (the idle drive gear 27a, the first idle driven gear 27b, the second idle driven gear 27c), the second intermediate shaft 16, the second speed gear pair 22 (the second speed drive bear 22a, the first common driven gear 23b) or the fourth speed gear pair 24 (the fourth speed drive gear 24a, the second common driven gear 24b), the counter shaft 14, the final gear 26a, the differential gear mechanism 8 and the drive shafts 9L, 9R.

(3) In a third transmission line, the crankshaft 6a of the engine 6 is connected to the driven wheels WL, WR via the first main shaft 11, the third speed gear pair 23 (the third speed drive gear 23a, the first common driven gear 23b) or the fifth speed gear pair 25 (the fifth speed drive gear 25a, the second common driven gear 24b), the counter shaft 14, the final gear 26a, the differential gear mechanism 8 and the drive shafts 9L, 9R without involving the planetary gear mechanism 30.

(4) In a fourth transmission line, the motor 7 is connected to the driven wheels WL, WR via the planetary gear mechanism 30 or the third speed gear pair 23 (the third speed drive gear 23a, the first common driven gear 23b) or the fifth speed gear pair 25 (the fifth speed drive gear 25a, the second common driven gear 24b), the counter shaft 14, the final gear 26a, the differential gear mechanism 8 and the drive shafts 9L, 9R.

(5) In a fifth transmission line, the crankshaft 6a of the engine 6 is connected to the driven wheels WL, WR via the second main shaft 12, the second idle gear train 27B (the idle drive gear 27a, the first idle driven gear 27b, the third idle driven gear 27d), the reverse shaft 17, the reverse gear train 28 (the reverse drive gear 28a, the reverse driven gear 28b), the planetary gear mechanism 30, the connecting shaft 13, the third speed gear pair 23 (the third speed drive gear 23a, the first common driven gear 23b), the counter shaft 14, the final gear 26a, the differential gear mechanism 8 and the drive shafts 9L, 9R.

The wheel speed sensors SL, SR detect the rotational speeds of the drive shafts 9L, 9R, respectively. The rotational speeds of the drive shafts 9L, 9R equal the rotational speeds of the driven wheel WL, WR, respectively. Signals signaling the rotational speeds that are detected by the wheel speed sensors SL, SR are sent to the control unit 2. The centrifugal acceleration sensor SG detects a centrifugal acceleration that is applied to the vehicle when it is cornering. A signal signaling the centrifugal acceleration that is detected by the centrifugal acceleration sensor SG is sent to the control unit 2.

The control unit 2 controls the engine 6, the motor 7 and the transmission 20. Namely, the control unit 2 outputs a signal that controls the engine 6, a signal that controls the motor 7, and signals that control the first gear shifter 51, the second gear shifter 52 and the reverse shifter 53 of the transmission 20, as well as a signal that controls the application (locking) and release (neutralizing) of the lock mechanism 61. Information is inputted into the control unit 2. The information includes pieces of information on the centrifugal acceleration detected by the centrifugal acceleration sensor SG, the rotational speeds of the driven wheels WL, WR that are detected by the wheel speed sensors SL, SR, the SOC that indicates the storage state of the battery 3, an accelerator pedal opening (AP opening), and the shift position of the transmission 20. The control unit 2 determines based on the centrifugal acceleration or a difference in rotational speed between the driven wheels WL, WR whether or not the vehicle is cornering. Further, the control unit 2 detects whether the lock mechanism 61 is engaged or disengaged and the respective positions of the first gear shifter 51 and the second gear shifter 52.

The control unit 2 controls the engagement and disengagement of the first clutch 41 and the second clutch 42 of the transmission 20 and controls (pre-shifts) the applying and engaging positions of the lock mechanism 61, the first gear shifter 51, the second gear shifter 52 and the reverse shifter 53, whereby the vehicle can be driven forwards in first- to fifth-speed gears and reversed by the engine 6.

When the vehicle is driven forwards in the first-speed gear, the control unit 2 applies the first clutch 41 and also applies the lock mechanism 61, whereby the driving force is transmitted to the driven wheels WL, WR by way of the first transmission line. When the vehicle is driven forwards in the second-speed gear, the control unit 2 applies the second clutch 42 and engages the second gear shifter 52 in the second speed engaging position, whereby the driving force is transmitted to the driven wheels WL, WR by way of the second transmission line. When the vehicle is driven forwards in the third-speed gear, the control unit 2 applies the first clutch 41 and engages the first gear shifter 51 in the third speed engaging position, whereby the driving force is transmitted to the driven wheels WL, WR by way of the third transmission line.

When the vehicle is driven forwards in the fourth-speed gear, the control unit 2 applies the first clutch 41 and engages the second gear shifter 52 in the fourth speed engaging position, whereby the driving force is transmitted to the driven wheels WL, WR by way of the second transmission line. When the vehicle is driven forwards in the fifth-speed gear, the control unit 2 engages the first gear shifter 51 in the fifth speed engaging position, whereby the driving force is transmitted to the driven wheels WL, WR by way of the third transmission line. When the vehicle is reversed, the control unit 2 applies the second clutch 42 and engages the reverse shifter 53, whereby the vehicle is reversed by the driving force transmitted by way of the fifth transmission line.

By applying the lock mechanism 61 or pre-shifting the first and second gear shifters 51, 52 while the vehicle is being driven by the engine, the motor 7 is allowed to assist the engine 6 to drive the vehicle or to execute regeneration. Further, even while the vehicle stays idle, the engine 6 can be started by the motor 7 and the battery 3 can be charged. The vehicle can be driven electrically by the motor 7 in an EV driving with the first and second clutches 41, 42 disengaged. As driving modes in the EV driving, there exist such driving modes as a first speed EV mode in which the vehicle is driven by the driving force transmitted by way of the fourth transmission line with the first and second clutches 41, 42 disengaged and the lock mechanism 61 applied, a third speed EV mode in which the vehicle is driven by the driving force transmitted by way of the fourth transmission line with the first gear shifter 51 engaged in the third speed engaging position, and a fifth speed EV mode in which the vehicle is driven by the driving force transmitted by way of the fourth transmission line with the first gear shifter 51 engaged in the fifth speed engaging position.

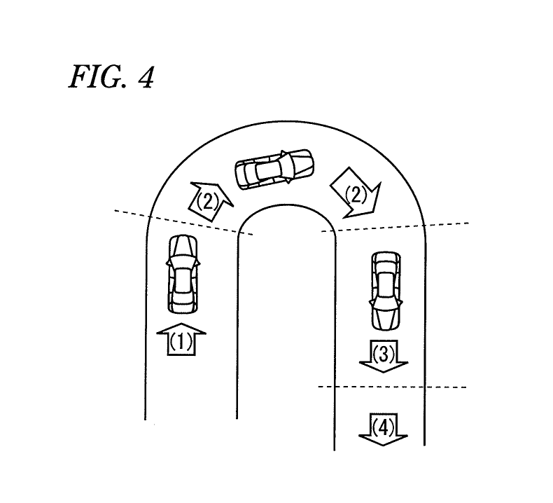

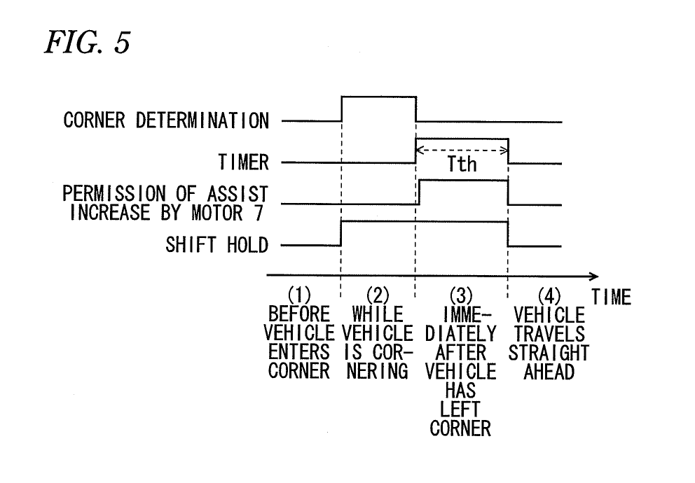

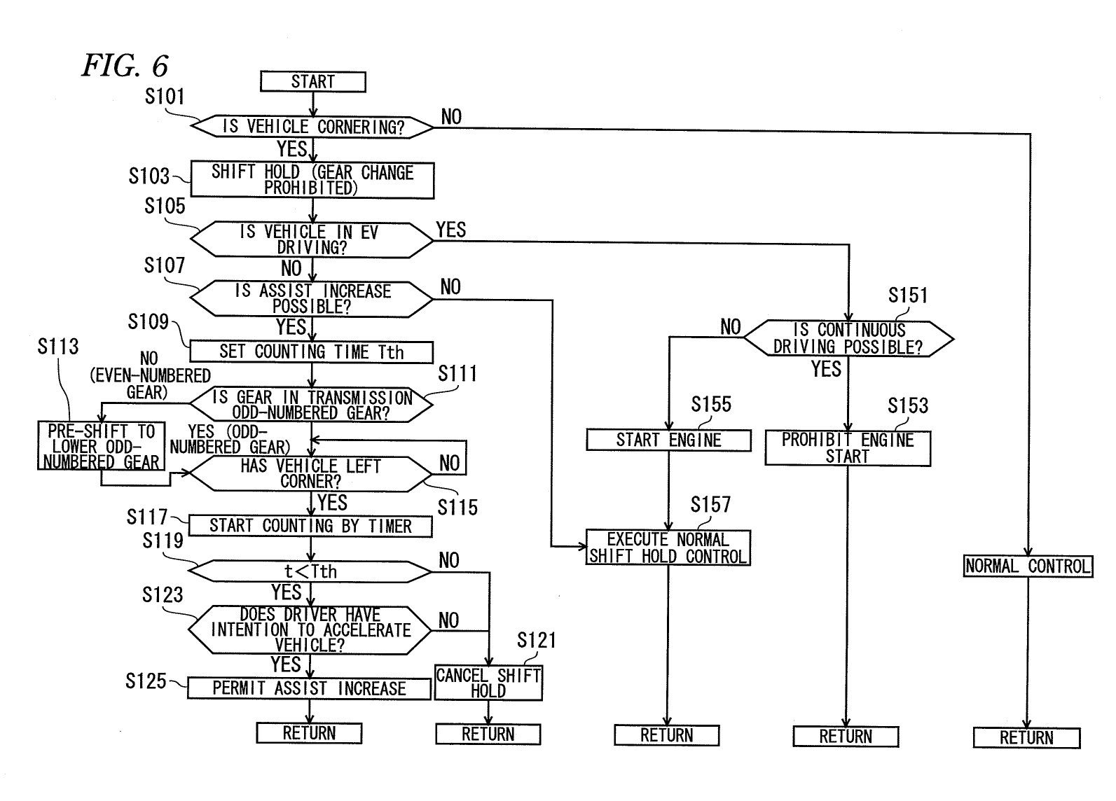

Hereinafter, controls executed by the control unit 2 when the vehicle is cornering (or is being driven along a bend in a road) will be described in detail by reference to FIGS. 4 to 6. FIG. 4 conceptually shows a cornering of the vehicle. FIG. 5 is a timing chart when the vehicle is cornering. FIG. 6 is a flowchart showing controls executed by the control unit 2 when the vehicle is cornering.

As shown in FIGS. 4 and 5, when the vehicle is cornering, the control unit 2 executes controls that correspond to driving stages of the vehicle including (1) a stage before the vehicle enters a bend or corner, (2) a stage where the vehicle is cornering, (3) a stage immediately after the vehicle has left the corner, and (4) a stage where the vehicle is traveling straight ahead. When the vehicle enters the corner and the driving stage is shifted from the stage (1) to the stage (2), the control unit 2 sets a flag to execute a corner determination and prohibits a gear change (executes a shift hold) in the transmission 20. Next, when the vehicle has left the corner and the driving stage is shifted from the stage (2) to the stage (3), the control unit 2 lowers the flag to execute the corner determination and starts counting by a timer. If there is a request for acceleration by the driver, the control unit 2 permits an assist or an increase in assist by the motor 7 (assist increase). While the vehicle stays in the stage (3), the shift hold is maintained. Next, when the timer counts a predetermined time period Tth and the driving stage is shifted from the stage (3) to the stage (4), the control unit 2 withdraws the permission for the motor 7 to execute the assist increase and cancels the shift hold.

In this way, in this embodiment, the vehicle is accelerated based on the assist increase by the motor 7 instead of changing gears so as to meet the request for acceleration by the driver during the predetermined time period Tth immediately after the vehicle has left the corner (the stage (3)). When the timer has finished counting the predetermined time period Tth (the stage (4)), a gear change is permitted. By accelerating the vehicle based on the assist increase by the motor 7 instead of changing gears, the frequent gear change can be prevented and an improvement in fuel economy can be realized by making use of the motor 7.

Hereinafter, referring to the flowchart in FIG. 6, the controls executed by the control unit 2 will be described in detail. The control unit 2 determines based on a centrifugal acceleration or a difference in rotational speed between the driven wheels WL, WR whether or not the vehicle is cornering (step S101). As this occurs, the control unit 2 determines that the vehicle is cornering when the centrifugal acceleration is larger than a first predetermined value or when the different in rotational speed is larger than a second predetermined value. If it is determined in step S101 that the vehicle is not cornering, the control unit 2 executes a normal control, whereas if it is determined that the vehicle is cornering, the control flow proceeds to step S103. In step S103, the control unit 2 prohibits a gear change (or executes a shift hold) in the transmission 20.

Next, the control unit 2 determines whether or not the vehicle is being driven in the EV driving (step S105). If it is determined in step S105 that the vehicle is not being driven in the EV driving, the control flow proceeds to step S107, whereas if it is determined that the vehicle is being driven in the EV driving, the control flow proceeds to step S151. In step S151, the control unit 2 determines based on the SOC of the battery 3 whether or not the vehicle can be driven in the EV driving continuously (whether or not the continuous driving is possible). As this occurs, the control unit 2 determines that the continuous driving of the vehicle is possible when the SOC is larger than a predetermined value. If it is determined in step S151 that the continuous driving of the vehicle is possible, the control flow proceeds to step S153, whereas if it is determined that the continuous driving of the vehicle is impossible, the control flow proceeds to step S155.

In step S153, the control unit 2 prohibits a start of the engine 6 by the motor 7. In this way, when the vehicle is being driven in the EV driving and the storage state of the battery 3 is so sufficient that the vehicle can carry on with the EV driving, by prohibiting the start of the engine 6, a shock associated with the start of the engine 6 or a change in driving force can be avoided. On the other hand, in step S155, the control unit 2 executes a control to start the engine 6 by the motor 7. After step S155, the control unit 2 executes a normal shift hold (step S157). The normal shift hold means a control involving a gear change immediately after the vehicle has left the corner or that a gear change is prohibited while the vehicle is cornering and a kickdown control is executed according to a request for acceleration immediately after the vehicle has left the corner. While the vehicle is cornering, the control unit 2 controls the transmission 20 to execute a pre-shift to a lower gear.

If the control flow proceeds to step S107 since it is determined in step S105 that the vehicle is not being driven in the EV driving, the control unit 2 determines based on the SOC of the battery 3 whether or not the assist by the motor 7 or the increase in assist by the motor 7 (the assist increase) is possible. As this occurs, the control unit 2 determines that the assist increase by the motor 7 is possible when the SOC is larger than the predetermined value. If it is determined in step S107 that the assist increase by the motor 7 is possible, the control flow proceeds to step S109, whereas if it is determined that the assist increase is impossible, the control flow proceeds to step S157. In step S109, the control unit 2 sets the time period Tth (counting time) that the timer counts in the aforesaid stage (3). A counting time Tth that is set when the sport mode is selected in which the driving performance is emphasized or when a puddle shift lever is operated is longer than a counting time Tth that is set when the vehicle is driven in the normal mode. Consequently, since a time period when a gear change is prohibited is long, a driving becomes possible in which a smooth acceleration performance based on the assist increase by the motor 7 is emphasized.

Next, the control unit 2 determines based on information on the shift position in the transmission 20 whether a gear that is set to be engaged in the transmission 20 is an odd-numbered gear or an even-numbered gear (step S111). If it is determined that the gear so set is an even-numbered gear, the control flow proceeds to step S113, whereas if it is determined that the gear so set is an odd-numbered gear, the control flow proceeds to step S115. In step S113, the control unit 2 controls the transmission 20 to execute a pre-shift (a pre-shift to a lower odd-numbered gear) by applying the lock mechanism 61 or engaging the first gear shifter 51 in the third speed engaging position. For example, a pre-shift to a lower gear when the vehicle is being driven in the second speed gear is executed by applying the lock mechanism 61, whereas a pre-shift to a lower gear when the vehicle is being driven in the fourth speed gear is executed by engaging the first gear shifter 51 in the third speed engaging position. However, as this occurs, the first clutch 41 is kept disengaged.

When executing a pre-shift to an odd-numbered gear in step S113, a control unit 2 may execute a pre-shift to an upper odd-numbered gear when a fuel economy prioritizing mode is selected in which fuel economy is prioritized, while when a sport mode is selected in which the driving performance is emphasized, the control unit 2 may execute a pre-shift to a lower odd-numbered gear. A pre-shift to an upper gear when the vehicle is driven in the second speed gear is executed by engaging the first gear shifter 51 in the third speed engaging position, and a pre-shift to an upper gear when the vehicle is driven in the fourth speed gear is executed by engaging the first gear shifter 51 in the fifth speed engaging position. As these occur, the first clutch 41 is also kept disengaged.

In step S113, the control unit 2 may execute gear changes to the odd-numbered gears instead of pre-shifting to the odd-numbered gears. As these occur, the first clutch 41 is applied, while the second clutch 42 is released. After having executed the control in step S113, the control unit 2 executes a control in step S115.

In step S115, the control unit 2 determines based on the centrifugal acceleration or the difference in rotational speed between the driven wheels WL, WR whether or not the vehicle has left the corner. As this occurs, the control unit 2 determines that the vehicle has left the corner when the centrifugal acceleration is equal to or smaller than the first predetermined value that is used in step S101 or the difference in rotational speed is equal to or smaller than the second predetermined value. If it is determined in step S115 that the vehicle has left the corner, the control flow proceeds to step S117.

In step S117, the control unit 2 starts counting by the timer. Next, the control unit 2 determines whether or not the time t that has elapsed since the start of the counting has exceeded the counting time Tth that was set in step S109 (step S119). If it is determined in step S119 that the time t that has elapsed has exceeded the counting time Tth (t≧Tth), the control flow proceeds to step S121, whereas if it is determined that the time t that has elapsed has not yet exceeded the counting time Tth (t<Tth), the control flow proceeds to step S123. In step S121, the control unit 2 cancels the shift hold that was set in step S103. Because of this, it is possible to execute an upshift in which the gear is changed to an upper gear in the transmission 20.

In step S123, the control unit 2 determines whether or not the driver has an intention to accelerate the vehicle. As this occurs, the control unit 2 determines that the driver has the intention to accelerate the vehicle when a change rate of AP opening is 50%/sec and the AP opening is larger than 50%. When determining on the intention of the driver to accelerate the vehicle, the control unit 2 may determine that the driver has the intention to accelerate the vehicle when the change rate of AP opening is larger than 50%/sec or the AP opening is larger than 50%.

If it is determined in step S123 that the driver has the intention to accelerate the vehicle, the control flow proceeds to step S125, whereas if it is determined that the driver has no intention to accelerate the vehicle, the control flow proceeds to step S121. In step S125, the control unit 2 permits the assist increase by the motor 7. As this occurs, since a frequent gear change is not executed in the transmission 20, neither a shock associated with a gear change nor a change in driving force occurs, and a driving force based on the assist increase by the motor 7 supplements the request for acceleration by the driver. Consequently, when the vehicle is cornering, it is possible to re-accelerate the vehicle in a smooth fashion after the vehicle has left the corner.

Thus, according to this embodiment, when the vehicle that is being driven by the driving force from at least the engine 6 has left the corner to be re-accelerated, in the event that the SOC of the battery 3 is sufficient, the assist by the motor 7 or the increase in assist by the motor 7 (the assist increase) is executed instead of changing gears in response to the request for acceleration within the predetermined time period immediately after the vehicle has left the corner.

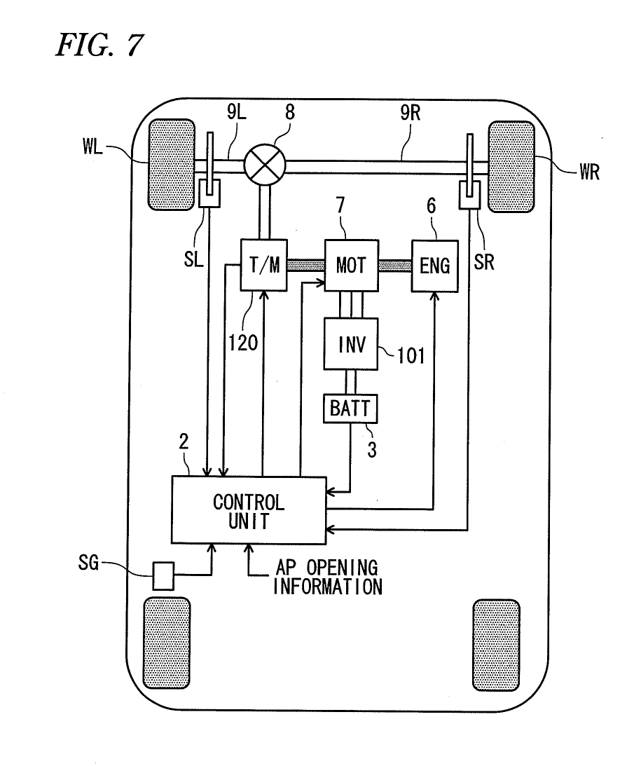

Although the dual-clutch transmission is exemplified as the transmission 20, the invention may also be applied to other types of transmissions such as a continuously variable transmission (CVT) or an automatic transmission (AT). FIG. 7 shows an internal configuration of an HEV that includes a different type of transmission. In the HEV (vehicle) shown in FIG. 7, a drive shaft of a motor 7 is connected directly to a drive shaft of an engine 6, so that the driving force of the motor 7 can assist the driving force of the engine 6. In the vehicle having this configuration, too, the timing chart shown in FIG. 5 remains available in a similar fashion. However, since a transmission 120 shown in FIG. 7 is not a dual-clutch transmission, the controls in steps S111 and S113 in the flowchart shown in FIG. 6 are not executed. Namely, the control in step S115 is executed after the control in step S109 has been executed. However, the invention is not limited to the configuration shown in FIG. 7 as long as the driving force of the motor can assist the driving force of the engine.

The vehicle may include a car navigation system, and the control unit 2 may obtain information on bends in a road from the car navigation system. As this occurs, the control unit 2 sets a gear to be engaged in the transmission 20, 120 according to a bend that the vehicle is about to enter.

While the invention has been described by reference to the specific embodiments, it is obvious to the skilled person that various alterations or modifications can be made thereto without departing from the spirit and scope of the invention.

This patent application is based on Japanese Patent Application (No. 2010-146291) filed on Jun. 28, 2010, the entire contents of which are incorporated herein by reference.

### DESCRIPTION OF REFERENCE NUMERALS AND CHARACTERS

2 Control unit
3 Battery
6 Engine (Internal combustion engine)
7 Motor (Electric motor)
11 First main shaft (First input shaft)
14 Counter shaft (Output shaft)
16 Second intermediate shaft (Second input shaft)
20, 120 Transmission
22a Second speed drive gear
23a Third speed drive gear
23b First common driven gear
24a Fourth speed drive gear
24b Second common driven gear
25a Fifth speed drive gear
30 Planetary gear mechanism
41 First clutch (First engaging and disengaging mechanism)
42 Second clutch (Second engaging and disengaging mechanism)
51 First gear shifter (First synchronizing unit)
52 Second gear shifter (Second synchronizing unit)
61 Lock mechanism (Synchronizer mechanism)
101 Inverter
SL, SR Wheel speed sensor
SG Centrifugal acceleration sensor

1. A vehicle control unit for use in a vehicle including:
an internal combustion engine;
an electric motor;
a battery that supplies electric power to the electric motor; and
a transmission that transmits a driving force from at least one of the internal combustion engine and the electric motor to drive shafts,
wherein, when a cornering of the vehicle is detected by a cornering detection device, a gear change in the transmission is prohibited at least when the vehicle is cornering, and when a storage state of the battery satisfies a first storage condition, an assist increase by the electric motor is permitted with the gear change in the transmission kept prohibited.

2. The control unit of claim 1,
wherein, when an accelerator pedal operation of an accelerator pedal of the vehicle satisfies a predetermined condition within a predetermined time period from a time point when an end of the cornering of the vehicle is detected by the cornering detection device, an assist increase in the electric motor is permitted, whereas when the accelerator pedal operation of the accelerator pedal of the vehicle does not satisfy the predetermined condition, the prohibition of the gear change in the transmission is cancelled.

3. The control unit of claim 1,
wherein, when the storage state of the battery does not satisfy the first storage condition, the prohibition of the gear change in the transmission is cancelled at the end of cornering of the vehicle.

4. The control unit of claim 1,
wherein, when the storage state of the battery satisfies a second storage condition while the vehicle is cornering which is driven only by a driving force from the electric motor, a start of the internal combustion engine is prohibited.

5. The control unit of claim 1,
wherein, when the storage state of the battery does not satisfy the second storage condition while the vehicle is cornering which is driven only by the driving force from the electric motor, it is controlled so that a start of the internal combustion engine by the electric motor is implemented.

6. The control unit of claim 1,
wherein the transmission includes:
a first input shaft that is connected to the electric motor and which is selectively connected to the internal combustion engine via a first engaging and disengaging mechanism
a second input shaft that is selectively connected to the internal combustion engine via a second engaging and disengaging mechanism;
an output shaft that outputs power to driven portions;
a first gear set made up of a plurality of odd-numbered gears that are disposed on the first input shaft and which are selectively connected to the first input shaft via a first synchronizing unit;
a second gear set made up of a plurality of even-numbered gears that are disposed on the second input shaft and which are selectively connected to the second input shaft via a second synchronizing unit; and
a third gear set made up of a plurality of gears that are disposed on the output shaft and with which the odd-numbered gears of the first gear set and the even-numbered gears of the second gear set are brought into meshing engagement.

7. The control unit of claim 6,
wherein, when the vehicle is cornering such that the first engaging and disengaging mechanism is released while the second engaging and disengaging mechanism is applied, the transmission is controlled so that the first input shaft is connected to one of the odd-numbered gears of the first gear set via the first synchronizing unit.

8. The control unit of claim 6,
wherein an odd-numbered gear of the first gear set that is connected to the first input shaft is lower than an even-numbered gear of the second gear set that is connected to the second input shaft.

9. The control unit of claim 6,
wherein, when a sport mode is selected in which a driving performance of the vehicle is emphasized, an odd-numbered gear that is lower than an even-numbered gear of the second gear set that is connected to the second input shaft is connected to the first input shaft.

10. The control unit of claim 7,
wherein, when a fuel economy prioritizing mode is selected in which fuel economy is prioritized, an odd-numbered gear that is upper than an even-numbered gear of the second gear set that is connected to the second input shaft is connected to the first input shaft.

11. The control unit of claim 2,
wherein the predetermined time period that is set when a sport mode is selected in which a driving performance of the vehicle is emphasized or when a gear change in the transmission is implemented manually is set longer than a time period set in a normal state.

12. The control unit of any one of claims 1 to 11,
wherein the vehicle includes a car navigation system, and
wherein a gear to be engaged in the transmission is set according to a bend in a road that the vehicle is about to enter based on information on the bend that is obtained from the car navigation system.

13. A vehicle control method for use in a vehicle including:
an internal combustion engine;
an electric motor;
a battery that supplies electric power to the electric motor;
a transmission that transmits a driving force from at least one of the internal combustion engine and the electric motor to drive shafts; and
a control unit that controls the electric motor and the transmission,
wherein, when a cornering of the vehicle is detected, the control unit prohibits a gear change in the transmission at least when the vehicle is cornering, and when a storage state of the battery satisfies a first storage condition, the control unit permits an assist increase in the electric motor with the gear change in the transmission kept prohibited.

14. The control unit claim 3,
wherein, when the storage state of the battery satisfies a second storage condition while the vehicle is cornering which is driven only by a driving force from the electric motor, a start of the internal combustion engine is prohibited.

15. The control unit of claim 4,
wherein, when the storage state of the battery does not satisfy the second storage condition while the vehicle is cornering which is driven only by the driving force from the electric motor, it is controlled so that a start of the internal combustion engine by the electric motor is implemented.

16. The control unit of claim 2,
wherein the transmission includes:
a first input shaft that is connected to the electric motor and which is selectively connected to the internal combustion engine via a first engaging and disengaging mechanism
a second input shaft that is selectively connected to the internal combustion engine via a second engaging and disengaging mechanism;
an output shaft that outputs power to driven portions;
a first gear set made up of a plurality of odd-numbered gears that are disposed on the first input shaft and which are selectively connected to the first input shaft via a first synchronizing unit;
a second gear set made up of a plurality of even-numbered gears that are disposed on the second input shaft and which are selectively connected to the second input shaft via a second synchronizing unit; and
a third gear set made up of a plurality of gears that are disposed on the output shaft and with which the odd-numbered gears of the first gear set and the even-numbered gears of the second gear set are brought into meshing engagement.

17. The control unit of claim 4,
wherein the transmission includes:
a first input shaft that is connected to the electric motor and which is selectively connected to the internal combustion engine via a first engaging and disengaging mechanism
a second input shaft that is selectively connected to the internal combustion engine via a second engaging and disengaging mechanism;
an output shaft that outputs power to driven portions;
a first gear set made up of a plurality of odd-numbered gears that are disposed on the first input shaft and which are selectively connected to the first input shaft via a first synchronizing unit;
a second gear set made up of a plurality of even-numbered gears that are disposed on the second input shaft and which are selectively connected to the second input shaft via a second synchronizing unit; and
a third gear set made up of a plurality of gears that are disposed on the output shaft and with which the odd-numbered gears of the first gear set and the even-numbered gears of the second gear set are brought into meshing engagement.

18. The control unit of claim 8,
wherein, when a fuel economy prioritizing mode is selected in which fuel economy is prioritized, an odd-numbered gear that is upper than an even-numbered gear of the second gear set that is connected to the second input shaft is connected to the first input shaft.

19. The control unit of claim 6,
wherein the predetermined time period that is set when a sport mode is selected in which a driving performance of the vehicle is emphasized or when a gear change in the transmission is implemented manually is set longer than a time period set in a normal state.
